(19) United States
(12) Patent Application Publication
(10) Pub. No.: US 2012/0016754 A1
(43) Pub. Date: Jan. 19, 2012

(54) FOOD SERVICE AND EVENT MANAGEMENT SYSTEM

(76) Inventor: Camille Marie Jackson, Inverness, CA (US)

(21) Appl. No.: 13/186,093

(22) Filed: Jul. 19, 2011

Related U.S. Application Data
(60) Provisional application No. 61/365,661, filed on Jul. 19, 2010.

(51) Int. Cl. G06Q 30/00

(52) U.S. Cl. 705/15

(57) ABSTRACT

A food service management system, method and computer-readable storage medium which includes a menu database. The menu database stores a menu organized by plates. A record of each of the plates includes: recipes, ingredients, season, dietary restriction, course, food cost, and menu pricing. A processor has an events module, a document generator, and an application interface. The application interface receives an electronic request to edit the plates on the menu from a user and forwards the request to the events module. The events module retrieves new plates from the menu database and populates the menu. The document generator configured to generate a revised menu and store the revised menu in the menu database. The document generator may then publish the revised menu on a printer or as a Cloud-based service via a computer network, such as the Internet.

### RELATED APPLICATIONS

This application claims priority to U.S. Provisional Patent Application No. 61/365,661, entitled “FOOD SERVICE AND EVENT MANAGEMENT SYSTEM,” filed Jul. 19, 2010.

### BACKGROUND

1. Field of the Invention

Aspects of the present disclosure relate in general to food service and event management systems. Aspects include a food management apparatus, system, method and computer-readable medium to display a real-time inventory based on dish ordering and menu items. Further aspects of the invention include a method of storing, displaying and scheduling events related to menu items ordered.

2. Description of the Related Art

The logistics of running a restaurant is a laborious task. Besides the issues relating to the tastiness of the food, restaurants require a huge amount of planning. Everything from coordination of menu items, worker scheduling, price structures for ingredients, preparation lists and material procurement are all each difficult processes that require restaurant management skills.

### SUMMARY

A food service management system, method and computer-readable storage medium stores a menu database. The menu database stores a menu organized by plates. A record of each of the plates includes: recipes, ingredients, season, dietary restriction, course, food cost, and menu pricing. A processor has an events module, a document generator, and an application interface. The application interface receives an electronic request to edit the plates on the menu from a user and forwards the request to the events module. The events module retrieves new plates from the menu database and populates the menu. The document generator configured to generate a revised menu and store the revised menu in the menu database. The document generator may then publish the revised menu on a printer or as a Cloud-based service via a computer network, such as the Internet.

### BRIEF DESCRIPTION OF THE DRAWINGS

FIG. 1 is a chart depicting a restaurant management system embodiment.

FIGS. 2A-2B are a chart showing menu management in a restaurant manager embodiment.

FIG. 3 illustrates a document management in a restaurant manager embodiment.

FIG. 4 is a diagram showing organization of services in a mobile device embodiment.

FIGS. 5A-5B are a chart showing event management in a calendar embodiment.

FIG. 6 shows the structure of a manager's log of a calendar embodiment.

FIG. 7 depicts a calendar embodiment.

FIGS. 8A-8B illustrate staff scheduling and staff organization in a calendar embodiment.

FIG. 9 is a sample view of a Today's To Do List of a calendar embodiment.

FIGS. 10A-10B show the organization of a chef's or restaurant manager's individual account in a restaurant management server embodiment.

FIG. 11 is a block diagram of a restaurant management server embodiment.

FIG. 12 is a detailed block diagram of specific aspects of the restaurant management server embodiment.

### DETAILED DESCRIPTION

One aspect of the present invention includes the realization that standardized recipe information may integrated with unit conversion functions, cost information, inventory information, photo displays, and other databases. Embodiments allow an individual chef, restaurant manager or other food service worker to separately and independently retain information in a manner that assists the worker in the context of working for a single employer, multiple employers or establishments.

Another aspect is the event management interface and supporting databases allow coordination of menu items, worker scheduling, price structures, preparation lists and material procurement instructions. Embodiments may facilitate seamless menu alterations, which may include the scheduling of tasting sessions, the seasonal availability of ingredients and accounting for the fluctuation of prices and calculations of fixed and marginal costs.

In restaurant manager server embodiments, automated inventory management occurs electronically, which may eliminate or reduce the number of traditional paper invoices, order forms, receipts and related physical documents. The disclosed inventory management system may continuously calculate average costs, average profits, inventory items on hand and reordering deadlines. The disclosed inventory management system features electronic ordering sheets that are quickly created from vendor price lists and that are easily categorized to assist in cost accounting and organization.

In some restaurant manager server embodiments, time management may occur on a global basis as well as tailored and controlled by each individual manager. The disclosed time management and calendaring features overcome shortfalls in the art by replacing a traditional communal managers log book.

A disclosed payroll system replaces traditional point of sale (POS) timecard systems that are susceptible to user fraud and honest mistakes, as four or more separate physical transactions may be required for each worker shift.

In one aspect, the ability to create standardized recipe information is integrated with unit conversion functions, cost information, inventory information, photo displays, and other databases. Embodiments of the invention allow an individual chef, restaurant manger or food service worker to separately and independently retain information in a manner that assists the worker in the context of working for multiple employers or establishments.

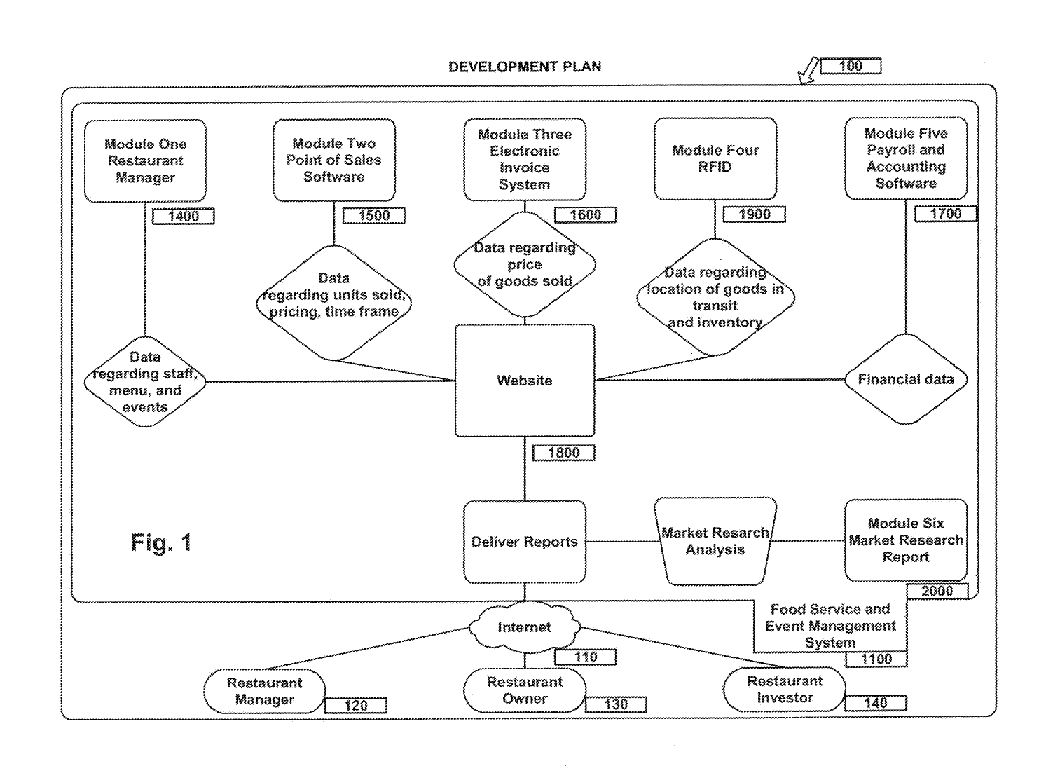

FIG. 1 depicts a system 100, constructed and operative in accordance with an embodiment of the present invention. As shown in FIG. 1, the system 100 allows restaurant manager 120, restaurant 130, and/or restaurant investor 140 to communicate with food service and event management system 1100 via a computer communications network 110, such as the Internet. Food service and event management system 1100 may include restaurant manager 1400, point of sales manager 1500, electronic invoice system 1600, Radio Frequency Identification (RFID) scanner 1900, payroll and accounting system 1700, market research report generator 2000, and web-server 1800. Data from the components may be distributed to remote users via the web-server 1800. From the website 1800, information is collected and distributed in various forms, including delivery reports, market research and analysis.

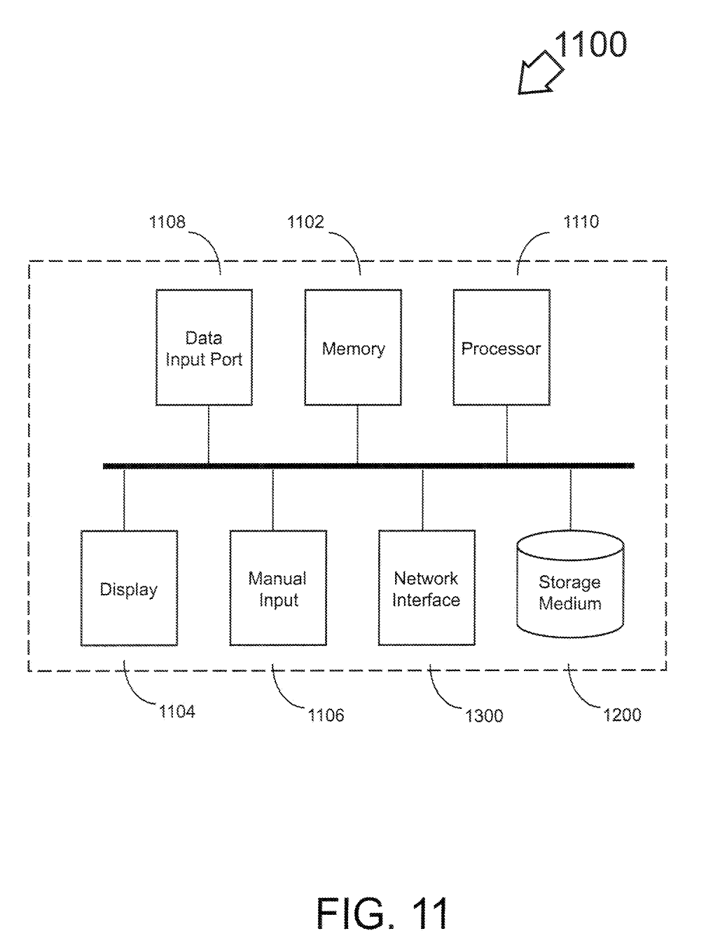

Turning to FIG. 11, FIG. 11 depicts food service and event management system 1100 in greater detail, where food service and event management system 1100 includes a system to support the calculation and display of a real-time management, accounting, and calendaring of restaurant services constructed and operative in accordance with an embodiment of the present invention. Food service and event management system 1100 may run a multi-tasking operating system (OS) and include at least one processor or central processing unit (CPU) 1110. Processor 1110 may be any microprocessor or micro-controller as is known in the art.

The software for programming the processor 1110 may be found at a computer-readable storage medium 1200 or, alternatively, from another location across a network via the world-wide-web. Processor 1110 is connected to computer memory 1102. Food service and event management system 1100 may be controlled by an operating system that is executed within computer memory 1102.

Processor 1110 communicates with a plurality of peripheral equipment, including network interface 1300. Additional peripheral equipment may include a display 1104, manual input device 1106, storage medium 1200, and data input port 1108.

As shown, in FIG. 11, food service and event management system 1100 comprises a processor 1110, memory 1102, a data input port 1108, display 1104, manual input 1106, a network interface 1300, and storage medium 1200.

Display 1104 may be a visual display such as a cathode ray tube (CRT) monitor, a liquid crystal display (LCD) screen, flat-panel display, touch-sensitive screen, or other monitors as are known in the art for visually displaying images and text to a user.

Manual input device 1106 may be a conventional keyboard, keypad, mouse, trackball, joystick, light pen, areas of a touch-sensitive screen or other input device as is known in the art for the manual input of data.

Storage medium 1200 may be a conventional read/write memory such as a magnetic disk drive, floppy disk drive, compact-disk read-only-memory (CD-ROM) drive, digital versatile disk (DVD) drive, flash memory, memory stick, transistor-based memory or other computer-readable memory device as is known in the art for storing and retrieving data. Significantly, storage medium 1200 may be remotely located from processor 1110, and be connected to processor 1110 via a network 110 such as a local area network (LAN), a wide area network (WAN), or the Internet.

Data input port 1108 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data input port 1108 may be any interface as known in the art for communicating or transferring files across a computer network, examples of such networks include Transmission Control Protocol/Internet Protocol (TCP/IP), Ethernet, Fiber Distributed Data Interface (FDDI), token bus, or token ring networks. In addition, on some systems, data input port 1108 may comprise a modem connected to network interface 1300. Similarly, in some embodiments network interface 1300 provides connectivity to food service and event management system 1100 to communicate with a network 110. Thus, the network interface 1300 allows the food service and event management system 1100 to communicate and process input and output from across a network.

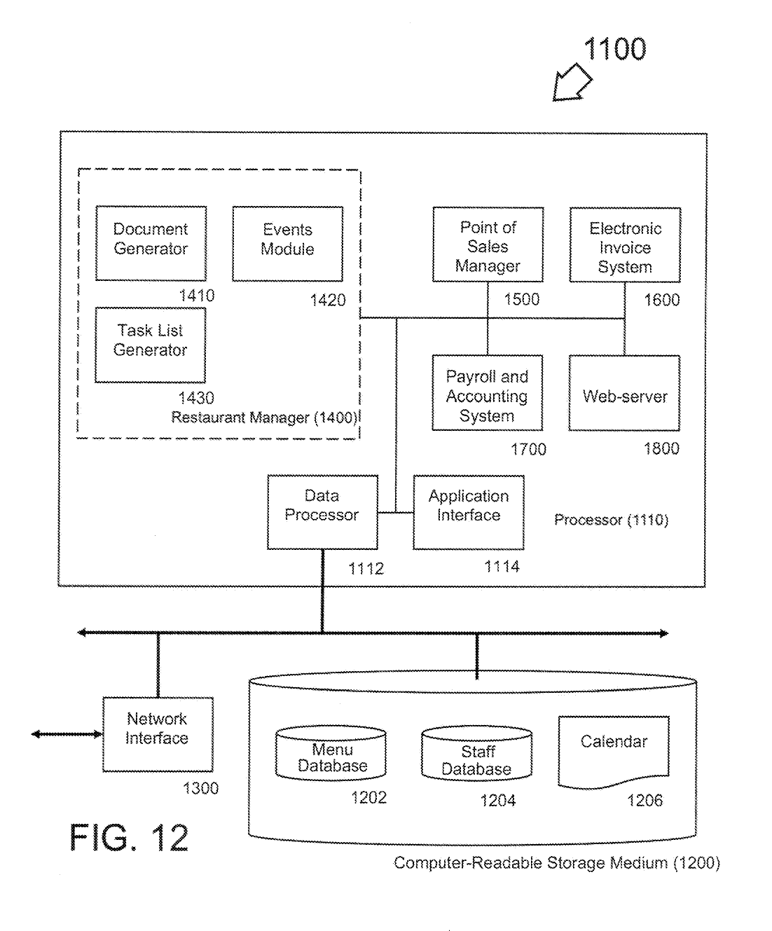

FIG. 12 is an expanded functional block diagram of food service and event management system 1100, constructed and operative in accordance with an embodiment of the present invention. It is well understood by those in the art, that the functional elements depicted within processor 1110 may be implemented in hardware, firmware, or as software instructions and data encoded on a computer-readable storage medium 1200. As shown in FIG. 12, processor 1110 is functionally comprised of a restaurant manager 1400, point of sales manager 1500, electronic invoice system 1600, payroll and accounting system 1700, web-server 1800, data processor 1112, and an application interface 1114. Restaurant manager 1400 may further comprise: document generator 1410, events module 1420, and task list generator 1430. These structures may be implemented as hardware, firmware, or software encoded on a computer readable medium, such as storage media 1200. Computer readable medium 1200 may also store a menu database 1202, staff database 1204, and a calendar 1206. The function of these structures may best be understood with respect to process flows, as described below.

Data processor 1112 interfaces with memory 1102, display 1104, manual input device 1106, storage medium 1200, data input port 1108, and network interface 216. The data processor 1112 enables processor 1110 to locate data on, read data from, and write data to, these components.

Application interface 1114 enables processor 1110 to take some action with respect to a separate software application or entity. For example, application interface 1114 may take the form of a window or touch-screen interface, as is commonly known in the art.

It is understood by those known in the art that menu database 1202 and staff database 1204 may be relational databases, as is known in the art. Menu database 1202 facilitates the storage and retrieval of menu, plate, and ingredient information. Similarly, staff database 1204 facilitates the storage and retrieval of restaurant employee information.

Operation of the food service and event management system embodiments may be illustrated by example.

We now turn our attention to method or process embodiments. It is understood by those known in the art that instructions for such method embodiments may be stored on a non-volatile programmable memory 1014 and executed by a processor 1008.

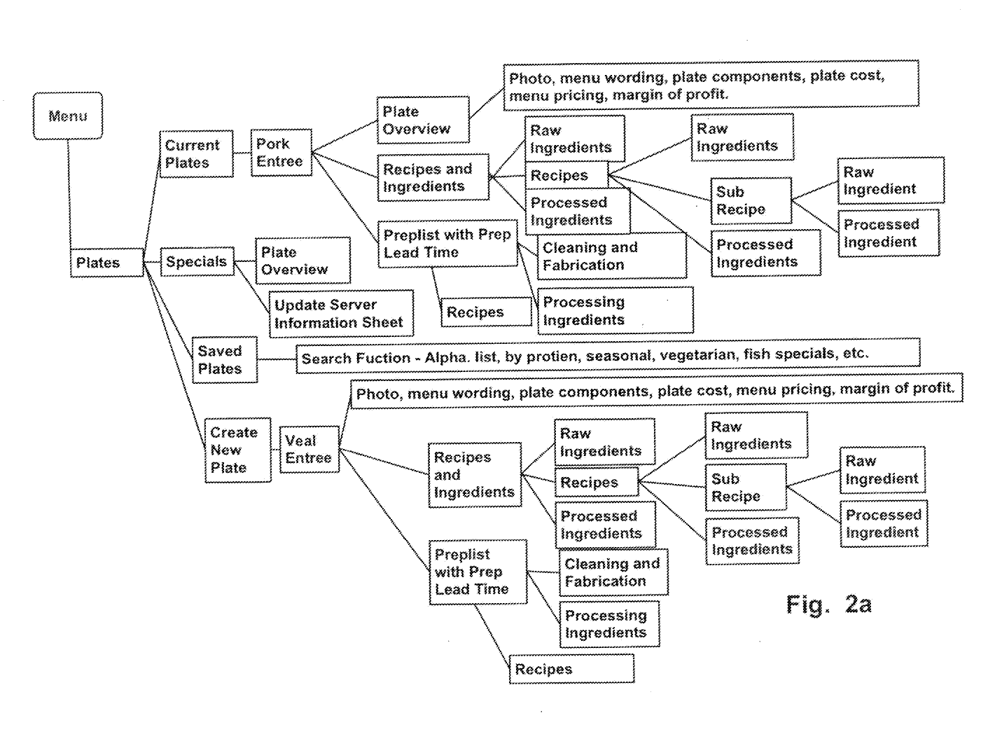

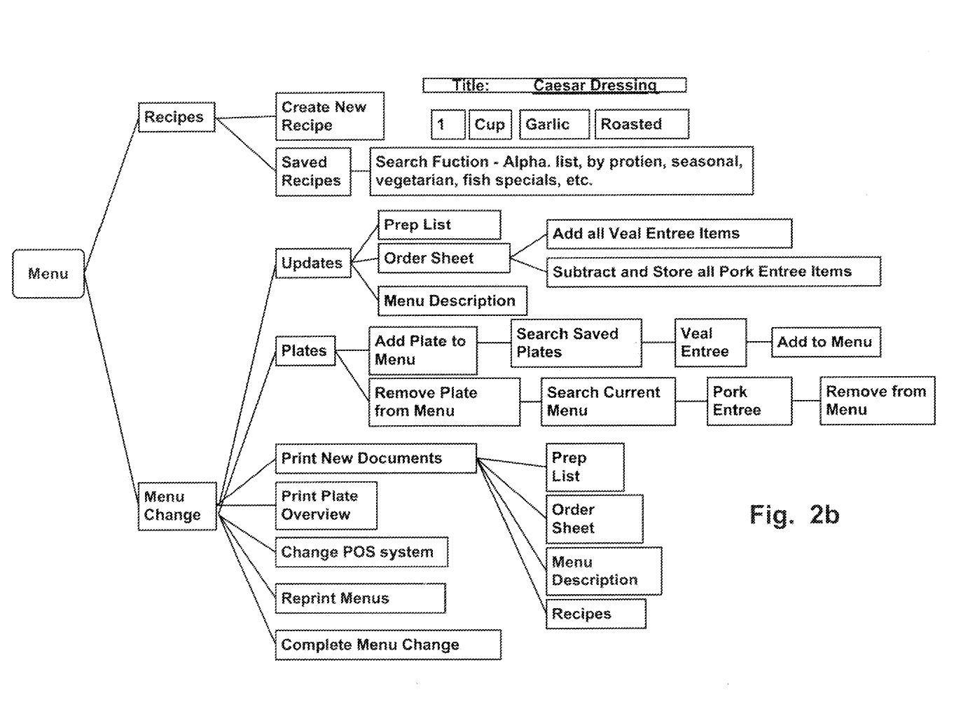

Referring to FIGS. 2A-2B, a flow of menu procedures, protocols, databases and search functions is presented, constructed and operative in accordance with an embodiment of the present invention. As mentioned above, restaurant manager 1400 has an events module 1420. Events module 1420 enables users to access menu database 1202, staff database 1204, and calendar 1206. In doing so, events module 1420 allows users to plan menus; the menu database 1202 may have three main categories comprising plates, recipes and menu changes. The plate category includes four main threads of current plates, specials, saved plates and create new plates. Plates may be stored as part of menu database 1202. In the creation of new plates of food, numerous sub categories are addressed and populated. Recipes and sub recipes are created and integrated with the main category of recipe. In some embodiments, the concept of plates includes beverages and cocktails, or any other item that may be included on a menu.

Recipes may also be stored in the menu database 1202. The second main category of recipe has two or more threads comprising create new recipe and saved recipe. In the saved recipe database any recipe may be accessed by searching categories such as protein, seasonal, vegetarian, specials and others. This information may also be stored in menu database 1202. A “specials” section allow for a editing of a plate with the least possible amount of information needed, and a searchable database of previous specials; specials which sell well may be easily converted to a saved plate and added to a menu. Recipes may be created in the system or uploaded via web-server. Saved recipes may be searchable by season, food costs, courses, and ingredients.

The third main category of menu change tackles the unexpectedly complex problem of changing a menu. As a menu is read or viewed by customers, a menu needs to accurately reflect the food and drink items for sale and a change in a menu results in cascading changes throughout the disclosed system. A menu may be sub categorized by plates, wherein each plate is created by use of a preparation list, order sheet, ingredient list, recipe and other elements. Events module 1420 uses document generator 1410 to enable creation of menus based on menu database 1202. Plates may be searchable by season, dietary restriction, course, food cost, ingredients, menu pricing or other predetermined or user-customizable parameters. For each plate entry, a list of necessary preparation tasks are attached, called a “prep list.” Each task on the prep list will be assigned a lead time, which is defined as the average time necessary to complete each task. In some embodiments, the prep list may be exported to a handheld mobile device, such as computer tablet device. In some embodiments, the prep list will have a “lock” option so that no changes may be made; in other embodiments, users may be permitted to add or subtract information.

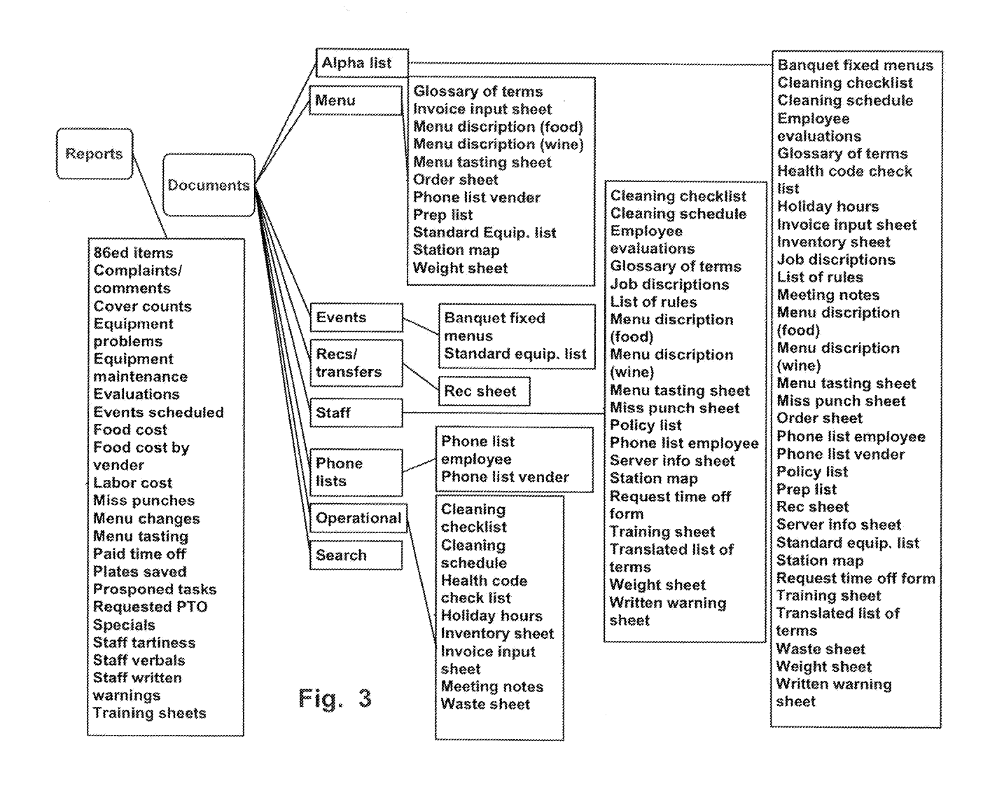

Moving to FIG. 3, a flow description and organization plan for the creation and distribution of documents is presented via a document generator 1410, constructed and operative in accordance with an embodiment of the present invention. Categories of documents that may be produced by document generator 1410 include an alpha list, menu, events, staff, records and transfers, phone and contact lists and operational documents. The category of staff documents, stored in staff database 1204, integrate with payroll and accounting system 1700. The document generator 1410 also facilitates the preparation of reports, such as the reports shown on the left-hand side of FIG. 3. Menus for guests may be generated with fonts and designs and automatically updated and printed. In some embodiments, document generator 1410 ties in with web-server 1800, so that when menus are changed, a resulting web-site menu is updated automatically. Menus may also be published on a printer (not shown) attached to food service and event management system 1100 or attached to network 110.

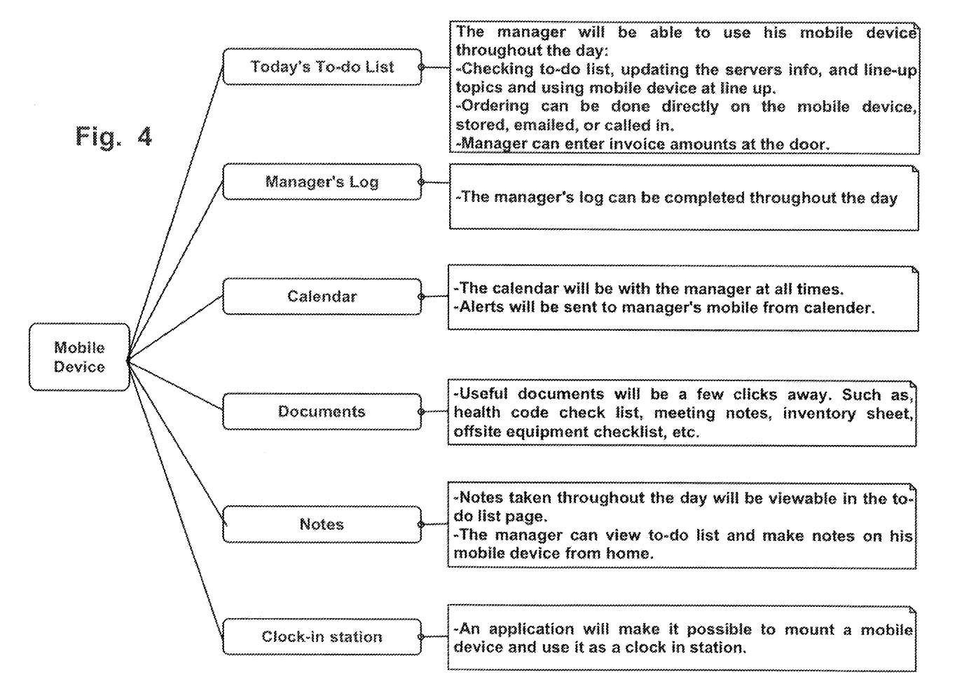

Referring to FIG. 4, various forms of integration with a tablet computer (such as an iPad™ or iPhone™ developed by Apple Inc. of Cupertino, Calif.) or other personal electronic device (“PED”) is shown, constructed and operative in accordance with an embodiment of the present invention. FIG. 4 presents a sample presentation of potential categories of information presented to a PED. Such information may also be accessed from the Internet via a web portal.

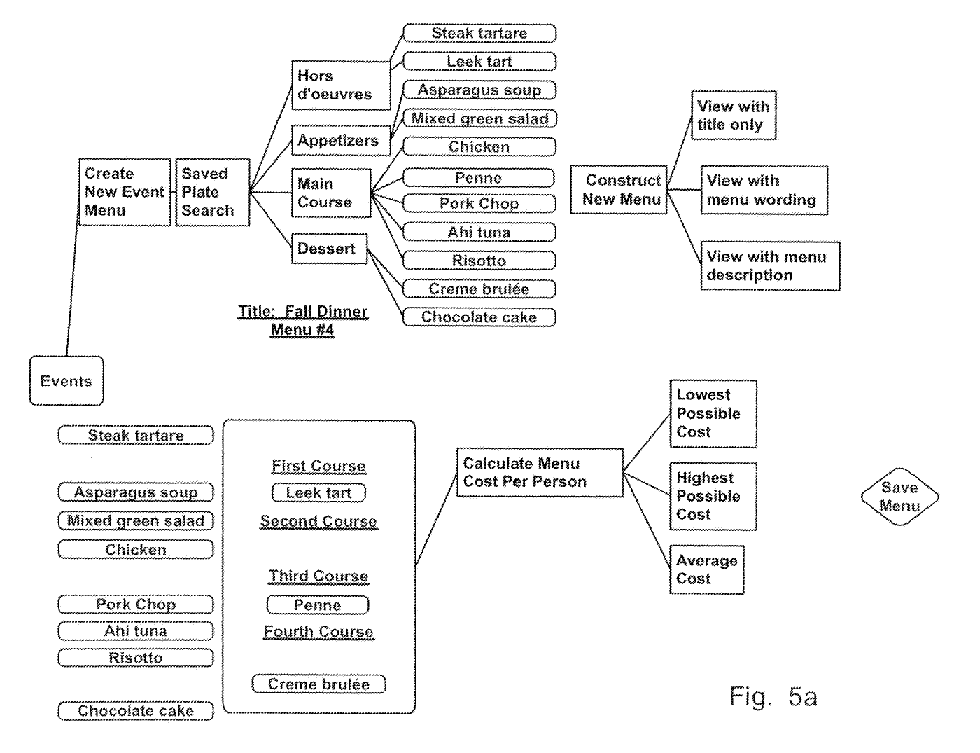

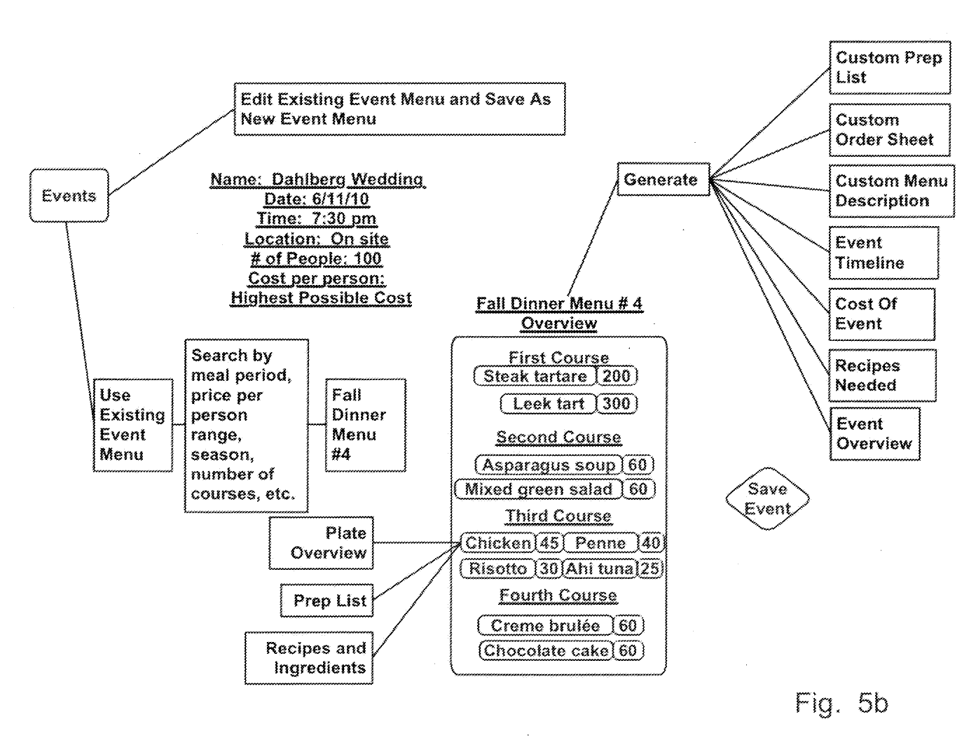

Turning to FIGS. 5A-5B, an outline of an events flow within the event module 1420 is presented, constructed and operative in accordance with an embodiment of the present invention. An event may be defined as a specific occurrence of a consumer occasion such as a wedding, birthday meal, wake, baby shower, bachelorette party or other gathering. Such events may be stored in calendar 1206. Events occurring at restaurants present special challenges to the chefs, restaurant manager, and other employees of the restaurant as the amount of food preparation is temporally increased and each event may have unique requirements.

The events module 1420 may handle multiple threads, such as create a new event menu, edit an existing event menu, save as a new event menu and use an existing event menu. The events module 1420 allows a chef or other user to retain past event information stored in calendar 1206 to create new variations or to reuse successful event menus of the past. The creation of a new menu section calls upon past menus to assist in creating new combinations of menus and recalling elements of past menus. Meals are parsed into courses and other subcategories.

After an event menu is generated, lists of raw materials, preparation lists and cost lists (derived from menu database 1202, electronic invoice system 1600, and payroll and accounting system 1700) are then generated by reference to costs and other retained information. The system may generate an event overview, event timeline and other documents unique to the particular event to be stored in calendar 1206, and shown at display 1104.

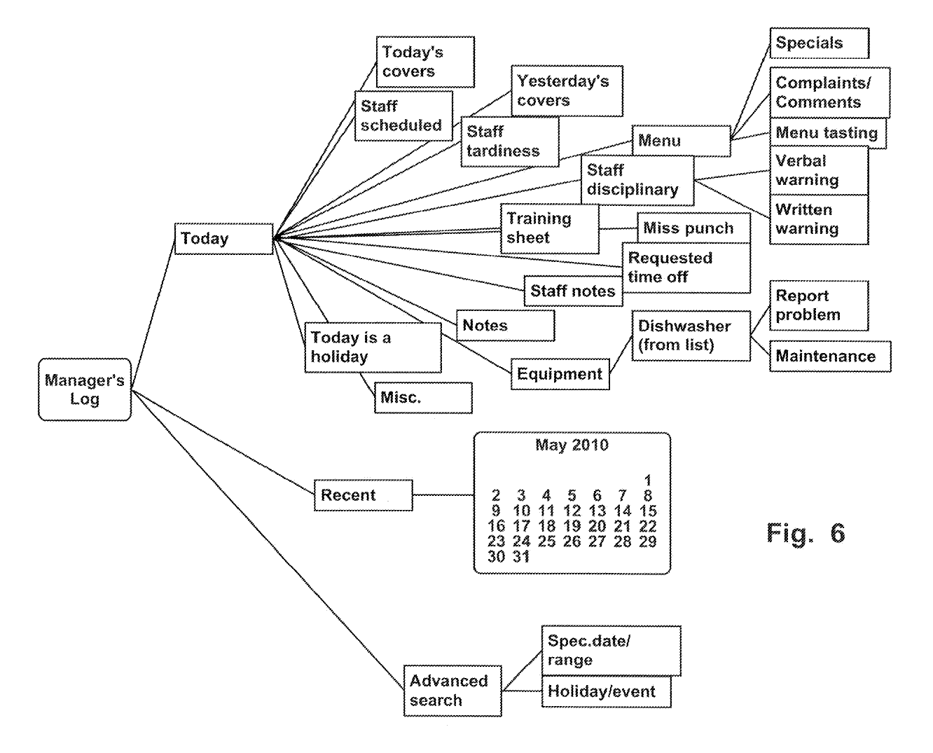

Referring to FIG. 6, events module 1420 facilitates a manager's log stored within calendar 1206; this embodiment is presented with three main categories: today, recent and advanced search, constructed and operative in accordance with an embodiment of the present invention. The manager's log includes staff scheduling, discipline, training, complaints and other human resource data elements. Calendar 1206 organizes data by date and assists in planning.

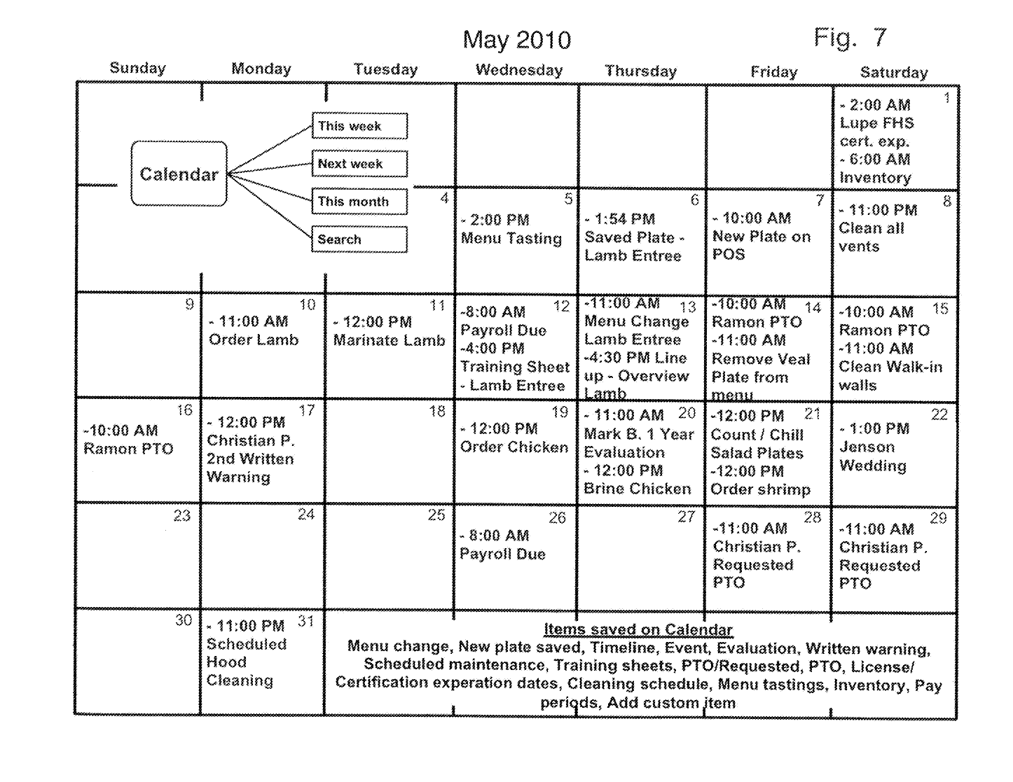

As shown in FIG. 7, a calendar 1206 includes four sample subcategories of this week, next week, this month and search, constructed and operative in accordance with an embodiment of the present invention. Efficient organization is facilitated by the use of color coordination, as shown to distinguish maintenance, staff, menu, and significant date. Data sets saved on a disclosed calendar include menu change, new plate saved, timeline, event, evaluation, written warning, scheduled maintenance, training sheets, menu tasting and other elements.

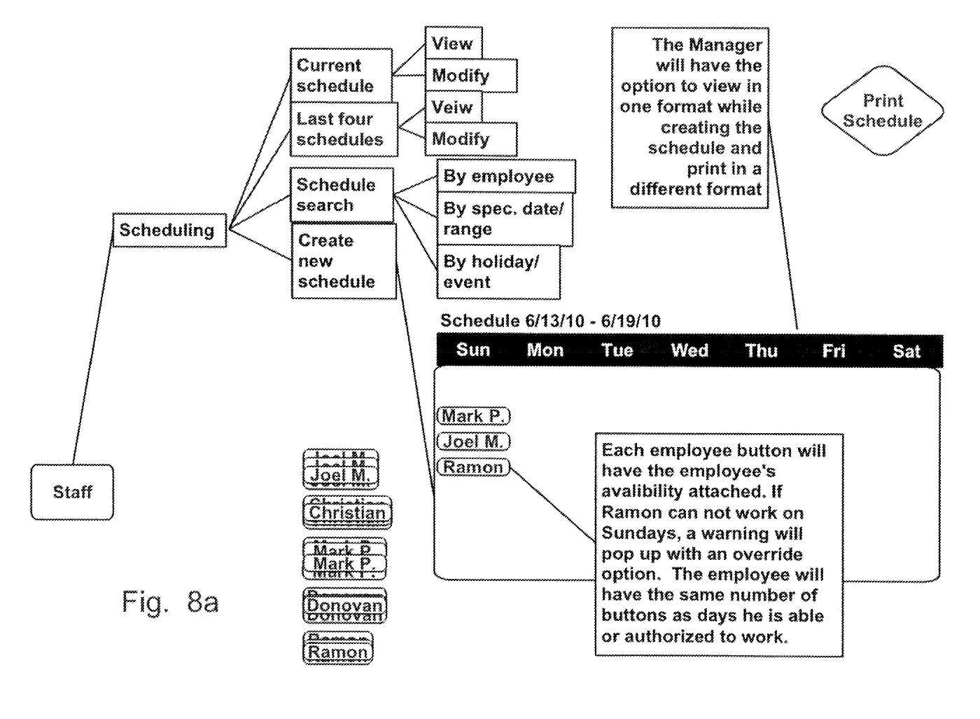

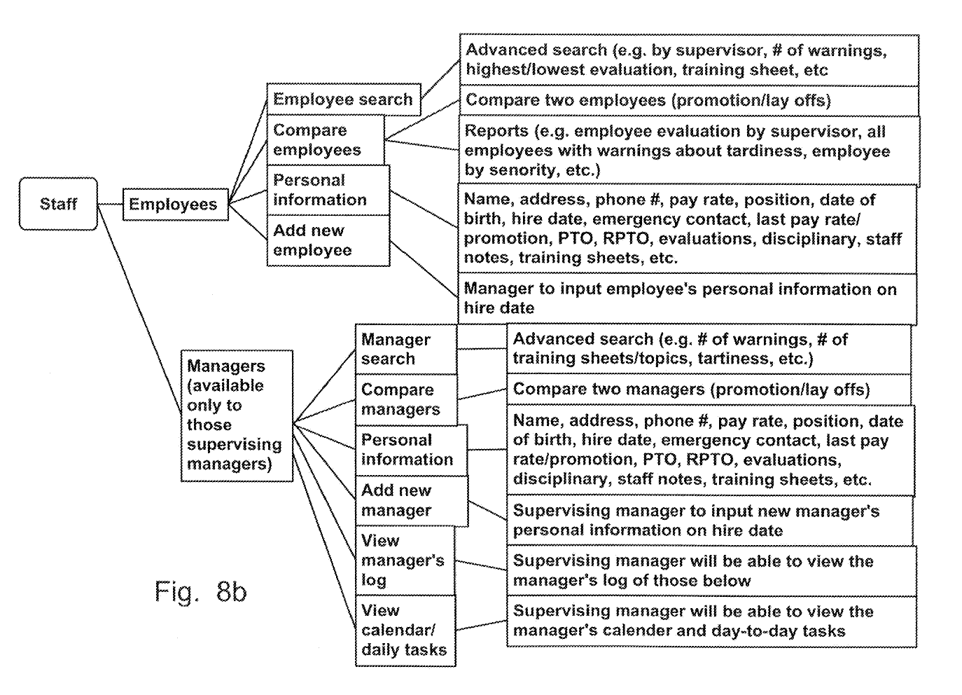

Referring to FIGS. 8A-8B events module 1420 allows handling and planning of employee scheduling is displayed, constructed and operative in accordance with an embodiment of the present invention. Employee data is stored in staff database 1204 and may be correlated with calendar 1206 by events module 1420. Employee information may be organized in three subcategories of scheduling, employees, supervising manager. In the supervising manager category, a sub manager's log is available and may mirror the manager's log of FIG. 6. FIGS. 8A-8B includes a sample calendar interface that may include the display of available employees for a selected time period.

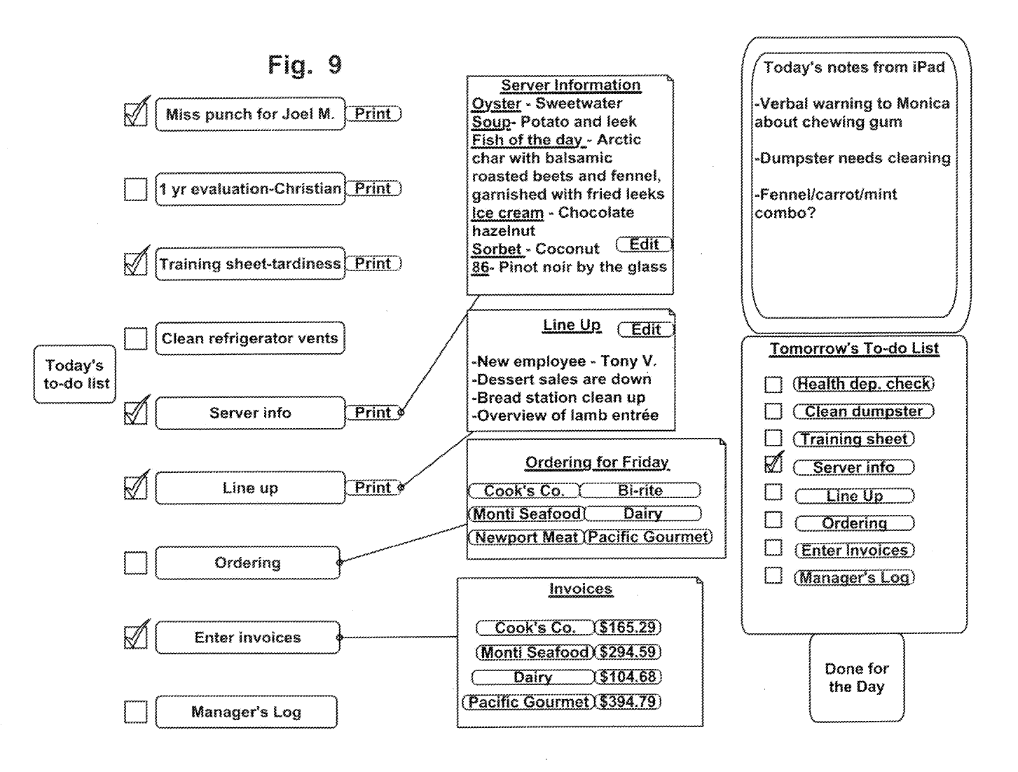

In FIG. 9, a sample task list flow is generated and shown by task list generator 1430, constructed and operative in accordance with an embodiment of the present invention. A today's to-do list is presented in the form of subcategories with radio buttons. For example, FIG. 9 shows server info checked with a pop-up window showing server information retrieved from staff database 1204. The to-do list may also be transmitted to a personal electronic device as shown in the upper right hand side of the figure.

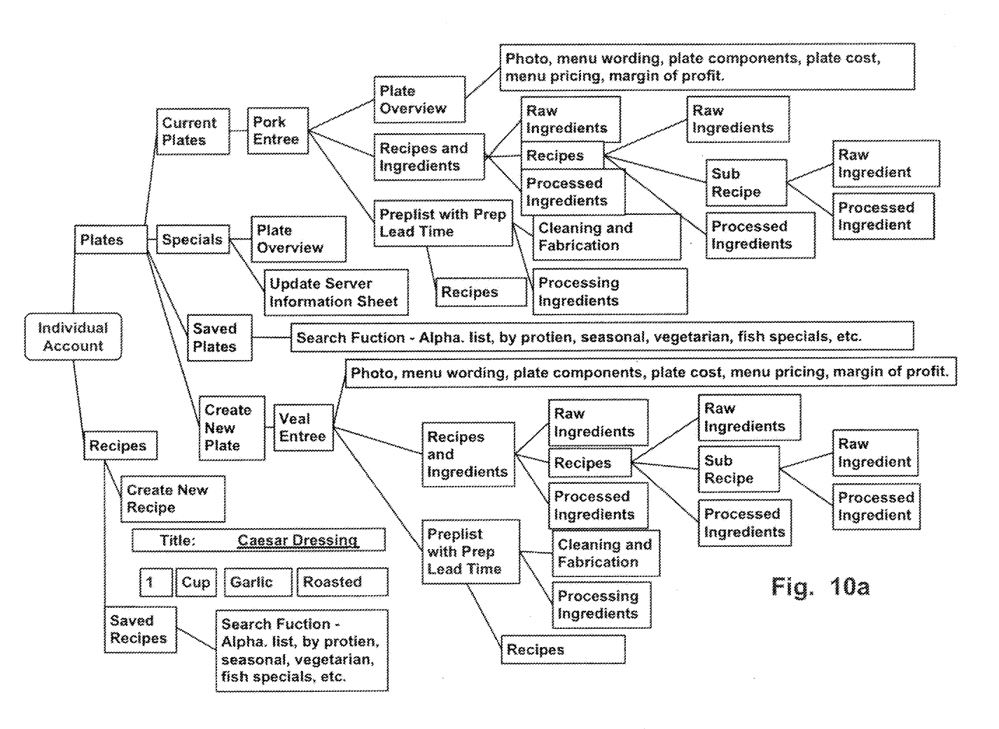

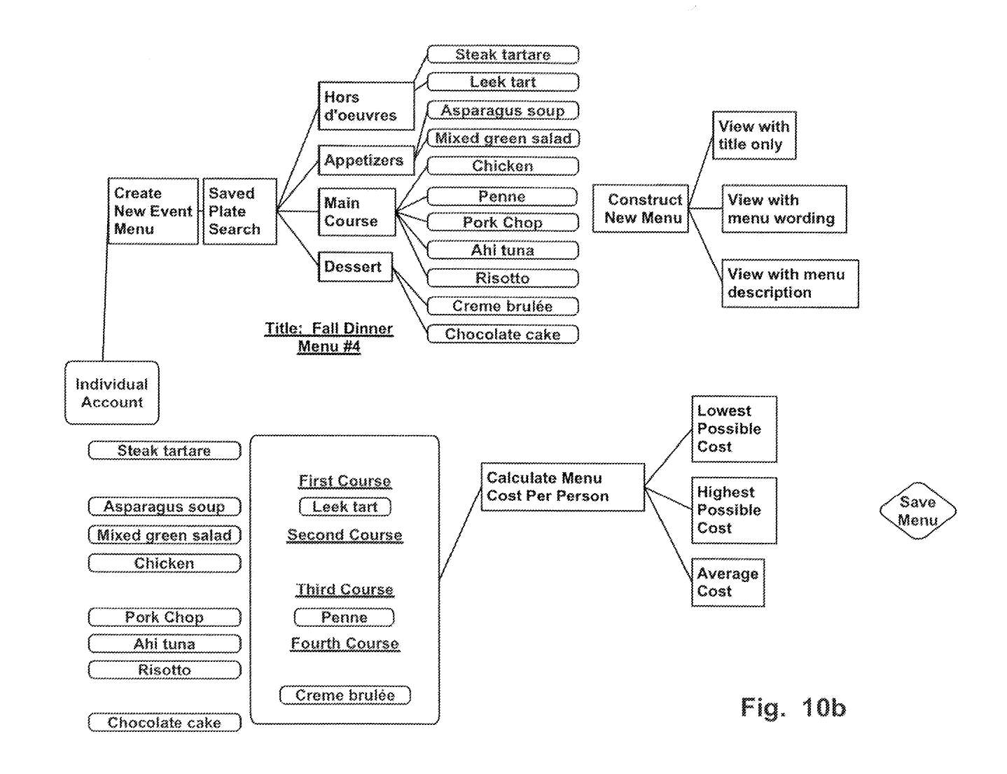

In some embodiments, menu database 1202 may be organized by individual accounts as shown in FIGS. 10A-10B, constructed and operative in accordance with an embodiment of the present invention. This embodiment may be a stand-alone implement or may integrate with the previously described embodiments.

In the individual accounts, a chef or other individual may store, access and organize information in a manner that is expedient to one in the food service industry. Three main categories, plates, recipes and new event menu sometimes mirror other portions of the disclosed system. A chef who travels from restaurant to restaurant may access successful plates, recipes and events of the past in a manner that easily integrates with the other portions of the invention that are used by a restaurant.

Individual accounts may be accessed remotely via the Internet, the Cloud, or any other computer network 110. Applications for PEDs allow a remote user to view home inventories of ingredients while out shopping and/or planning meals. A home user module also facilitates integration with other domestic agendas such as shopping lists for house cleaning items, house maintenance, animal care, child care, elder care, vehicle care and other tasks. Thus, a homemaker or home user may have a complete list of shopping items to cover food preparation, general home events and other domestic responsibilities.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. A food service management system comprising:
a non-volatile computer-readable storage medium configured to store a menu database, the menu database being configured to store a menu organized by plates, a record of each of the plates comprising recipes, ingredients, season, dietary restriction, course, food cost, and menu pricing;
a processor configured with an events module, a document generator, and an application interface;
the application interface, configured to receive an electronic request to edit the plates on the menu from a user of the food service management system, and further configured to forward the request to the events module;
the events module configured to retrieve new plates from the menu database and populate the menu;
the document generator configured to generate a revised menu and store the revised menu in the menu database.

2. The food service management system of claim 1 further comprising:
a network interface, coupled with the processor, configured to communicate with the user via a computer network.

3. The food service management system of claim 2, wherein the processor is further configured with a web-server configured to receive the revised menu from the document generator and distribute the revised menu over the computer network via the network interface.

4. The food service management system of claim 3, wherein the document manager is further configured to send the revised menu to a printer coupled to the food service management system.

5. The food service management system of claim 4, wherein the record of the plates also comprises a prep list including a lead time for the plate.

6. The food service management system of claim 5, wherein the record of the plates also comprises a menu price for the plate.

7. The food service management system of claim 6, wherein the events module prompts the user to enter the menu price for the plate.

8. The food service management system of claim 7, wherein the revised menu includes the menu price for the plate.

9. The food service management system of claim 8, further comprising:
a payroll and accounting system, configured to calculate the food cost in the record of the plates.

10. A food service management method comprising:
receiving, at a computer processor, an electronic request to edit plates on a menu from a user,
retrieving the menu from a menu database encoded on a computer-readable medium, the menu being organized by plates, a record of each of the plates comprising recipes, ingredients, season, dietary restriction, course, food cost, and menu pricing;
retrieving new plates from the menu database and populating the menu;
generating a revised menu; and
storing the revised menu in the menu database.

11. The food service management method of claim 10 further comprising:
communicating with the user via a computer network.

12. The food service management method of claim 11, further comprising:
distributing the revised menu over the computer network via a network interface.

13. The food service management method of claim 12, further comprising:
sending the revised menu to a printer.

14. The food service management method of claim 13, wherein the record of the plates also comprises a prep list including a lead time for the plate.

15. The food service management method of claim 14, wherein the record of the plates also comprises a menu price for the plate.

16. The food service management method of claim 15, further comprising:
prompting the user to enter the menu price for the plate.

17. The food service management method of claim 16, wherein the revised menu includes the menu price for the plate.

18. The food service management method of claim 17, further comprising:
a payroll and accounting method, configured to calculate the food cost in the record of the plates.

19. A computer-readable storage medium, encoded with data and instructions, such that when executed by a device, the instructions causes the device to:
receive, at a computer processor, an electronic request to edit plates on a menu from a user,
retrieve the menu from a menu database encoded on a computer-readable medium, the menu being organized by plates, a record of each of the plates comprising recipes, ingredients, season, dietary restriction, course, food cost, and menu pricing;
retrieve new plates from the menu database and populating the menu;
generate a revised menu; and
store the revised menu in the menu database.

20. The computer-readable medium of claim 19, the instructions further comprising:
communicate with the user via a computer network.
